(19) United States
(12) Patent Application Publication
(10) Pub. No.: US 2025/0007215 A1
(43) Pub. Date: Jan. 2, 2025

(54) CHARGE CONNECTION SYSTEM FOR A MOTOR VEHICLE

(71) Applicant: BOS GMBH & CO. KG, Ostfildern (DE)

(72) Inventors: Samuel ADAMS, Kalamazoo, MI (US); Patricia MALLOY, Rochester Hills, MI (US); Satya Akhil Reddy BACHUGUDAM, Rochester Hills, MI (US)

(21) Appl. No.: 18/755,959

(22) Filed: Jun. 27, 2024

Related U.S. Application Data
(60) Provisional application No. 63/510,988, filed on Jun. 29, 2023.

(51) Int. Cl. H01R 13/635; B60L 53/16; H01R 13/639

(52) U.S. Cl. CPC H01R 13/635; B60L 53/16; H01R 13/639; H01R 2201/26

(57) ABSTRACT

A charge connection system for use with a passenger car with an electric drive, including an electric charging socket on the vehicle side designed for coupling to a charging plug, and an electrically activatable locking device associated with the charging socket for securing the charging plug in the charging socket. The locking device has a mechanical emergency unlocking unit which is activatable by means of a remote transmission cable coupled to a manually operable actuating element which is movably mounted on the vehicle side.

### CROSS REFERENCE TO RELATED APPLICATION

This claims priority of U.S. Provisional Application No. 63/510,988, filed Jun. 29, 2023, the disclosure of which is hereby incorporated by reference in its entirety.

### TECHNICAL FIELD

The invention relates to a charge connection system for a motor vehicle, with an electric charging socket on the vehicle side designed for coupling to a charging plug and with an electrically activatable locking device associated with the charging socket for securing the charging plug in the charging socket.

### BACKGROUND AND SUMMARY

A charge connection system of this type is generally known for passenger cars. A passenger car has, in the area of an outer bodywork surface, a stationary electric charging socket which is closable by a charger flap. If a charging plug of a charging cable is plugged into the charging socket, unauthorized removal of the charging plug from the vehicle, and hence from the charging socket of the passenger car, must be prevented. An electrically activatable locking device which secures the charging plug in the charging socket is provided to do so. The locking device is electrically deactivated again after the end of charging, allowing the charging plug to be removed from the charging socket.

An object underlying the invention is to provide a charge connection system of the type mentioned at the outset which permits disconnection of the charging plug from the charging socket even in the event of a power failure or a power interruption caused by other circumstances.

This is achieved in that the locking device has a mechanical emergency unlocking unit which is activatable by means of a remote transmission string coupled to a manually operable actuating element which is movably mounted on the vehicle side. The solution in accordance with the invention is suitable in a particularly advantageous manner for passenger cars in which a corresponding electric charging socket is accessible from an outer vehicle side and is closed by a cover or flap when not in use. The charge connection system in accordance with the invention is however also usable for other motor vehicles, land, water or air. The solution in accordance with the invention permits removal of a charging plug of a charging cable located in the charging socket even when a power failure or a power interruption at the motor vehicle or in the area of a charging station causes a failure in electrical activation or deactivation of the locking device.

In one embodiment of the invention, the locking device has a mechanical switching element arranged on the outside of a housing of the locking device and mounted swivelably about a swivel axis between a blocking position locking the charging plug relative to the charging socket and an opening position releasing the charging plug for removal from the charging socket, and the emergency unlocking unit has a control element which positively grips around the switching element and is swivelably mounted coaxially to the switching element on the vehicle side. The switching element of the locking device is electrically movable between its blocking position and its opening position. The electrically movable section of the switching element is preferably provided on the inside of the housing of the locking device. The switching element outside permits mechanical ending of the block and thus of the secured state of the charging plug relative to the charging socket. To do so the control element is provided, which positively grips over the mechanical switching element arranged on the outside. Due to the swivelability of the control element coaxially to the switching element, a swivel movement of the control element in at least one direction inevitably causes a switching operation of the switching element, preferably a movement of the switching element out of the blocking position and into the opening position. The positive grip around the switching element by means of the control element is preferably designed such that the control element moves the switching element too out of the blocking position in the direction of the opening position. At the same time, however, sufficient free space is provided at the control element, in particular in the form of a cutaway area, which permits swiveling of the switching element between the blocking position and the opening position by appropriate electrical activation while the control element remains stationary, without said control element blocking such electrical swiveling of the switching element. The control element is thus exclusively provided to swivel the switching element out of the blocking position and into opening position in the event of a power supply failure. The control element is then automatically swiveled back into its initial position, wherein the free space already mentioned previously permits swiveling of the control element back into its initial position without the switching element too being unintentionally moved back in the direction of the blocking position.

In a further development of the invention, the control element is mechanically coupled to the remote transmission string. Preferably, the remote transmission string is designed flexible, preferably in the form of a rope, cable or Bowden cable, advantageously in the form of a metal wire rope or high-tensile plastic rope respectively.

In a further embodiment of the invention, the remote transmission string is designed flexible, a stationary carrier element is provided which has guide elements for linear guidance of the remote transmission string, and an end area of the remote transmission string at a distance from the actuating element is mechanically coupled to the control element. A movement of the actuating element is accordingly transmitted by the remote transmission string to a movement of the control element, resulting in the switching element of the locking device being movable from the blocking position into the opening position. Preferably, the actuating element is arranged on the vehicle side such that it is accessible from the outside of the vehicle in the event of a power failure at the motor vehicle. The actuating element may also be arranged in the area of a vehicle's interior lining or in the area of a trunk lining of a front or rear vehicle trunk. Alternatively, the actuating element may be provided in the area of a vehicle's outer contour, preferably such that unauthorized access is made impossible. The guide elements of the carrier element are preferably designed as groove or duct sections for linear guidance of the remote transmission cable, in particular of a rope or cable.

In a further embodiment of the invention, the guide elements of the carrier element have a deflector for the remote transmission string, and a circumferential-side outer contour of the control element has a circular-arc-shaped guide for the remote transmission string that extends coaxially to the swivel axis of the control element. The deflector is used to permanently apply a tensile load to the remote transmission string directed such that as an inevitable result the switching element is forced into a swivel movement in the direction of the opening position.

In a further embodiment of the invention, the deflector of the carrier element is configured as a 180° deflector for the remote transmission string, and a transition of the remote transmission string from the carrier element to the circular-arc-shaped outer contour of the control element is designed such that the flexible remote transmission string enters tangentially to the outer contour of the control element. The tangential engagement of the remote transmission string with the circumferential-side outer contour of the control element ensures a particularly low expenditure of force for swiveling the control element, since the remote transmission string engages the control element with the maximum lever arm.

In a further embodiment of the invention, the remote transmission string is designed as a wire Bowden cable which is mechanically connected at its opposite ends to the actuating element on the one side and to the control element at the other. The wire Bowden cable may be formed by a wire rope strand, by a plastic rope strand or also by a wire or plastic cable. At the ends, the wire Bowden cable is advantageously positively connected to the actuating element or to the control element with the aid of closing elements of enlarged diameter.

In a further embodiment of the invention, the carrier element has a bearing extension for rotatable mounting of the control element. The control element is thus mounted exclusively on the carrier element, making a retrofitted solution possible for existing locking devices too.

In a further embodiment of the invention, the carrier element has end stops for limiting the rotatability of the control element, which are matched to a swivel path of the switching element between the blocking position and the opening position such that depending on the rotation direction the control element does not make contact with the respective end stop until the control element has moved the switching element into the opening position or blocking position. The switching element is here moved from the blocking position into the opening position by corresponding mechanical actuation of the control element, and from the opening position into the blocking position by corresponding resetting by means of the reset spring.

### BRIEF DESCRIPTION OF THE DRAWINGS

Further advantages and features of the invention can be found in the claims and in the following description of a preferred example of the invention explained on the basis of the drawing.

FIG. 1 shows schematically a partial area of an embodiment of a charge connection system in accordance with the invention for a passenger car, with representation of an actuating element in the area of a trunk lining;

FIG. 2 shows in an enlarged perspective representation a charge connection system in the area of a fender of a passenger car from an interior;

FIG. 3 shows in an enlarged perspective representation a partial area of the charge connection system in the area of a locking device with a mechanical emergency unlocking unit, wherein the representation is shown, for a better understanding, in a different alignment than that in the following representations according to FIGS. 5 and 6;

FIG. 4 shows in a perspective exploded view the emergency unlocking unit for the locking device of the charge connection system according to FIGS. 1 to 3;

FIG. 5 the charge connection system according to FIGS. 1 to 3 in a side view; and

FIG. 6 the charge connection system according to FIG. 5, however in a section plane parallel to FIG. 5.

### DETAILED DESCRIPTION

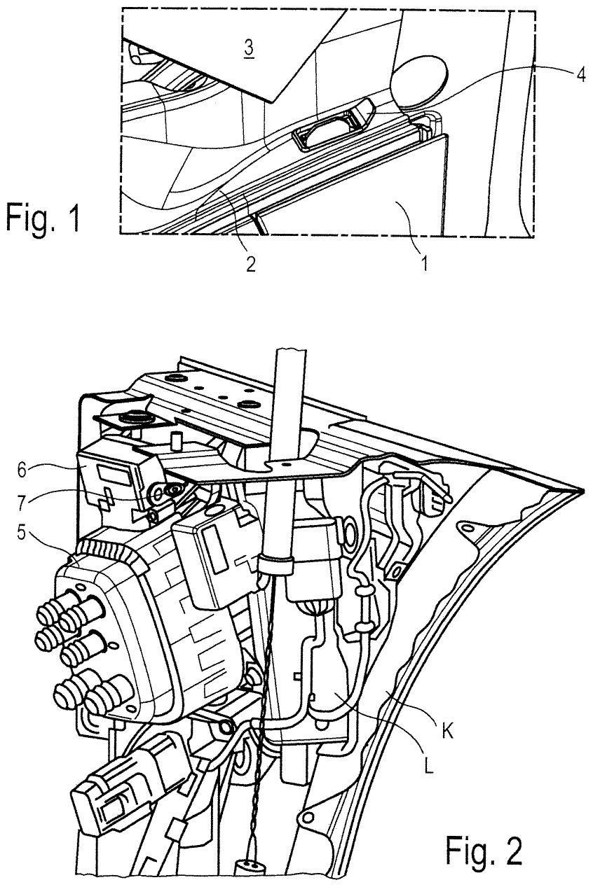

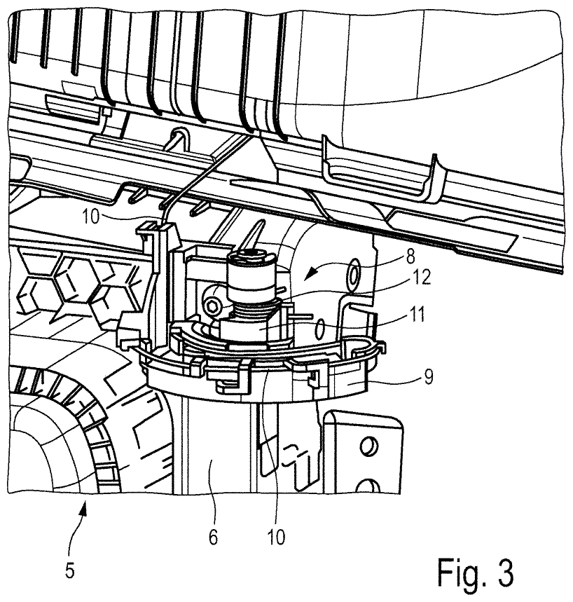

A passenger car shown only in sections in FIGS. 1 to 3 is provided with an electric drive. This electric drive may be provided either exclusively for movement of the passenger car or as an additional drive beside a combustion engine. To operate the electric drive, power storage in the form of a rechargeable battery is provided in the passenger car. To charge the battery, an embodiment shown in FIGS. 1 to 6 of a charge connection system in accordance with the invention is provided. The charge connection system has a vehicle-side charging recess L which is accommodated in a lateral fender K. The charging recess L is closable by a cover 1, preferably in the form of a charger flap which, in its closed position covering the charging recess L, is flush with an outer bodywork surface of the passenger car. The charging recess accommodates a charging socket 5 which is connected to the battery via power cable in a manner not shown in detail. The charging socket 5 is provided for reception and insertion of a charging plug of a charging cable, which is routed from the outside of a vehicle to the charging recess L and plugged into the charging socket 5. The outside is provided on the side facing away at the rear in FIG. 2 in the drawing.

To prevent the charging plug being removed from the charging socket 5 in unauthorized manner in its charging state while plugged into the charging socket 5, a locking device 6 is provided at the charging socket 5, which is attached to the outside of a housing of the charging socket 5 and engages in the inside of the charging socket 5 by means of at least one locking element in a manner not shown, in order to positively secure the charging plug in its charging state while plugged into the charging socket 5. A movement of this locking element into the locked position or into the release position is achieved by electrical activation of the locking element.

To permit a release of the charging plug in the charging socket 5 for removal of said charging plug from said charging socket 5 even in the event of a power failure or power interruption, the locking element of the locking device 6 is mechanically coupled to a switching element 7 which is swivelably arranged on the outside of a housing of the locking device 6. The switching element 7 is swivelably mounted in two different end positions, of which one corresponds to the locked state of the locking element of the locking device 6 and the other to the release position of the locking element of the locking device 6.

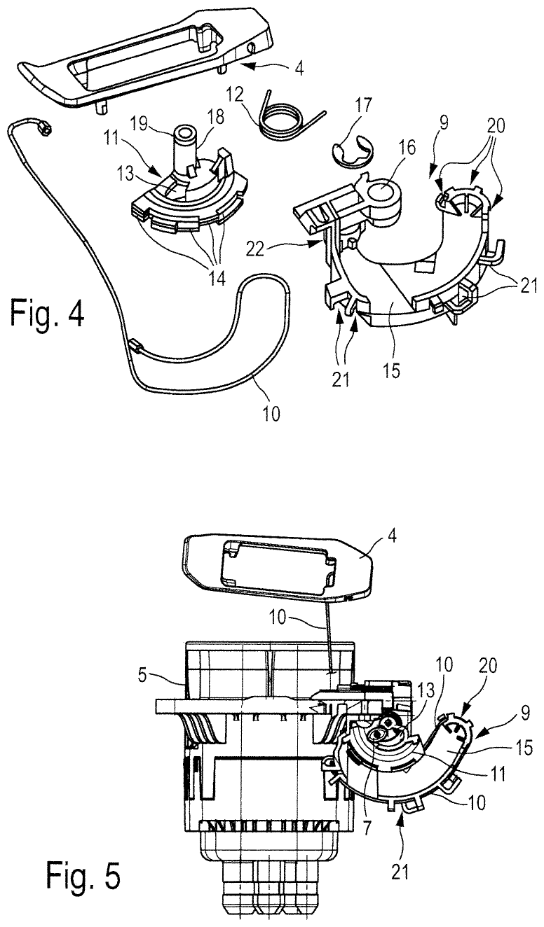

This switching element 7 is mechanically actuated by an emergency unlocking unit, described in more detail in the following and shown in detail in FIGS. 1 to 6, in the event of a power failure or power interruption. The emergency unlocking unit has, according to FIG. 4, a control element 11 which is provided with a receptacle 13 designed as a cutout which positively grips over the switching element 7 in at least one swivel direction. The control element 11 is swivelably mounted coaxially to the switching element 7. To do so, the control element 11 has a bearing journal 18 which is rotatably mounted in a bearing bush 16 of a carrier element 9. The carrier element 9 is, in the assembled operating state, firmly connected to the housing of the charging socket 5, so that the carrier element 9 is fitted permanently in the vehicle in a state ready for operation.

The control element 11 has a partial circular arc section, projecting eccentrically from the bearing journal 18 and radially to the axis of rotation of the bearing journal 18 and on whose circumferential-side outer contour guide profiles 14 are provided for the laying of a Bowden cable 10, as described in more detail in the following. The guide profiles 14, the circular arc section and the bearing journal 18 are made out of plastic and in one piece. The receptacle 13 in the circular arc section has, in the rotation direction of the control element, lateral edge contours which are matched to an outer contour of the switching element 7, in order to permit a flush and planar contact of the receptacle 13 with the switching element 7.

It is also discernible from FIG. 5 that the receptacle 13, which positively encloses the switching element 7 in at least one rotation direction, is cut away such that the control element 11 may, after movement of the switching element 7 into the unlocked release position, again be swiveled back into the initial position by the resetting force of the reset spring 12, without the switching element 7 too being moved back again. The receptacle 13 is substantially longer in the rotation direction of the control element than the thickness of the switching element 7 and accordingly forms with its cutaway area a free run for the control element 11. Only when a charging plug has again been plugged into the charging socket 5 does the switching element 7 inevitably swivel back into its blocking position, without the control element 11 too being moved. This is because it is already automatically swiveled by the resetting force of the reset spring 12 back into the initial position, i.e. the blocking position of the switching element 7, as soon as the manually applied tensile load on the remote transmission string in the form of the Bowden cable 10 has been removed. The cutaway area permits swiveling back into the initial position.

The carrier element 9 too is a one-piece plastic component. The bearing bush 16 is supported by a fastening section 22, which serves to fasten the carrier element 9 on the housing of the charging socket 5. Axially offset from the bearing bush 16—relative to an axis of rotation of said bearing bush 16—an arc-shaped guide section 15, which in the fitted state is in the radial plane of the circular arc section of the control element 11, is integrally molded on the fastening section 22. The arc-shaped guide section 15 surrounds an outer circumference of the circular arc section of the control element 11 over part of its circumference. The arc-shaped guide section 15 is provided with guide profiles 21 on its outer circumference, which also serve to guide the Bowden cable 10. In addition, deflection profiles 20, which effect a deflection of the Bowden cable 10 by 180°, are provided on the outside on a freely projecting extension nose of the arc-shaped guide section 15. The fastening section 22 too is provided with a guide eyelet, not indicated in detail, which guides the Bowden cable axis-parallel to the axis of rotation of the bearing bush 16 as far as the radial plane of the guide profiles 21.

The laying of the Bowden cable 10 is readily discernible in FIG. 4. The Bowden cable 10 is, according to the representation in FIG. 4, passed from above through the guide eyelet of the fastening section 22, then deflected into the radial plane of the guide profiles 21 on the outer circumference of the arc-shaped guide section 15, and finally deflected by 180° in the area of the deflection profiles 20 and introduced into the guide profiles 14 of the circular arc section of the control element 11 which is rotatable in the same radial plane as the arc-shaped guide section 15. As a result, the Bowden cable, extending from the deflection profiles 20, is guided tangentially to the circular-arc-shaped outer contour of the guide profiles 14 of the circular arc section of the control element 11. An end closing element of the Bowden cable 10 is positively secured in an end guide section of the guide profiles 14 on the control element 11.

In the state assembled ready for operation, the bearing journal 18 is inserted into the bearing bush 16 from an underside-relative to the representation according to FIG. 4—wherein the bearing journal 18 is secured in the bearing bush 16 by a corresponding ring 17 which engages in an annular groove of the bearing journal 18 in the area of an upper side of the bearing bush 16, as soon as the bearing journal 18 has been completely coaxially inserted into the bearing bush 16. A reset spring 12, designed as a torsion spring arranged coaxially to the axis of rotation of the bearing bush 16, permanently exerts a torque on the control element 11 in the direction of a blocking position of the control element 11, and hence in the direction of the locked end position of the switching element 7.

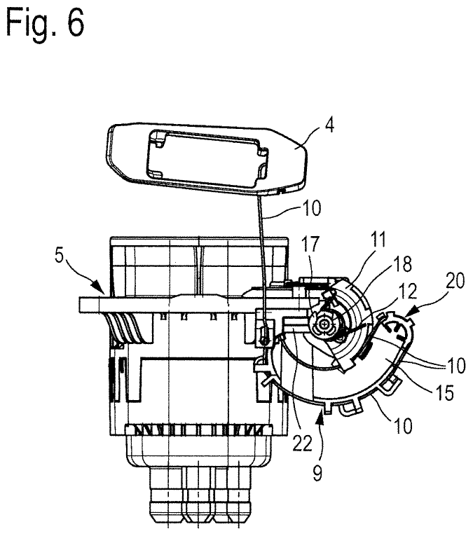

In the case of a tensile load on the Bowden cable 10 in its state laid ready for operation, the control element 11 is thus rotated anti-clockwise about the axis of rotation of the bearing bush 16 out of its initial position according to FIG. 5 and into the other end position shown in FIG. 6. Due to the swiveling of the control element 11, the switching element 7 too is inevitably moved, from its locked position into its release position, in which the locking element of the locking device 6 releases the charging plug. The charging plug may thus be removed from the charging socket.

To exert a tensile load on the Bowden cable 10, which represents a remote transmission cable in the meaning of the invention, an end section opposite the closing element of the Bowden cable 10 is provided with a further closing element mechanically coupled to an actuating element 4. Both closing elements have a greater diameter than the wire of the Bowden cable. The actuating element 4 is movably mounted on the vehicle side of a lining section 2 of a front trunk. The front trunk is closable by a trunk hood 3 which is a part of the outer bodywork surface of the passenger car. In the example shown, the actuating element 4 is swivelably mounted. Since the front closing element of the Bowden cable 10 is firmly connected to the actuating element 4 at a distance to the swivel axis of the actuating element 4, a swivel movement of the actuating element 4 inevitably leads to the required tensile load on the Bowden cable 10, thus effecting the required swiveling of the control element 11.

The control element 11 and the carrier element 9 have stop profiles complementary to one another, not indicated in detail, which form end stops for a limited rotatability of the control element 11 in both rotation directions of the control element 11 relative to the bearing extension of the fastening section 22 which supports the bearing bush 16. FIGS. 5 and 6 show the two different end positions of the control element 11 relative to the carrier element 9.

1. A charge connection system for a motor vehicle having an electric charging socket on a vehicle side configured for coupling to a charging plug, the charge connection system comprising an electrically activatable locking device associated with the charging socket for securing the charging plug in the charging socket, the locking device having a mechanical emergency unlocking unit activatable by a remote transmission string coupled to a manually operable actuating element movably mounted on the vehicle side.

2. The charge connection system according to claim 1, wherein the locking device includes has a mechanical switching element arranged on an outside of a housing of the locking device and mounted swivelably about a swivel axis between a blocking position locking the charging plug relative to the charging socket and an opening position releasing the charging plug for removal from the charging socket, and in that the emergency unlocking unit having a control element, the control element positively gripping around the switching element and being swivelably mounted coaxially to the switching element on the vehicle side.

3. The charge connection system according to claim 2, wherein the control element is mechanically coupled to the remote transmission string.

4. The charge connection system according to claim 3, wherein the remote transmission string is flexible, and the charge connection system further includes a stationary carrier element including guide elements, the guide elements comprising at least one guide profile, at least one deflection profile and a guide eyelet for linear guidance of the remote transmission string, and the remote transmission string includes an end area spaced at a distance from the actuating element and mechanically coupled to the control element.

5. The charge connection system according to claim 4, wherein the at least one deflection profile of the stationary carrier element includes a deflector configured for deflecting the remote transmission string, and the control element has a circumferential-side outer contour including a circular-arc-shaped guide for the remote transmission string, the circular-arc-shaped guide extending coaxially to the swivel axis of the control element.

6. The charge connection system according to claim 5, wherein the deflector of the stationary carrier element is configured as a 180° deflector for the remote transmission string, and a transition of the remote transmission string from the stationary carrier element to the circumferential-side outer contour of the control element is configured such that the remote transmission string enters tangentially to the outer contour of the control element.

7. The charge connection system according to claim 1, further including a reset spring disposed to exert a permanent torque on the control element in a direction of the blocking position of the switching element.

8. The charge connection system according to claim 1, wherein the remote transmission string comprises a wire Bowden cable firmly connected at one end to the actuating element and firmly connected at an opposite end and to the control element.

9. The charge connection system according to claim 4, wherein the carrier element has a bearing extension for rotatable mounting of the control element.

10. The charge connection system according to claim 4, wherein the carrier element has end stops for limiting rotatability of the control element, the end stops being matched to a swivel path of the switching element between the blocking position and the opening position such that, depending on a rotation direction the control element, the control element does not make contact with the respective end stop until the control element has moved the switching element into the opening position or blocking position.
